(19) United States
(12) Patent Application Publication
(10) Pub. No.: US 2009/0273721 A1
(43) Pub. Date: Nov. 5, 2009

(54) Multi-View Display Using Light Pipes

(76) Inventor: Michael Dhuey, Cupertino, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 12/018,335

(22) Filed: Jan. 23, 2008

(51) Int. Cl. H04N 5/66; H04N 3/14

(52) U.S. Cl. 348/790; 348/739; 348/E03.017; 348/E05.133

(57) ABSTRACT

A system and method for generating multiple images on a video display device is described. The method comprises associating a panel of light pipes with a video display device. The video display device is configured to display an interlaced plurality of individual video signals. The plurality of video signals are displayed on the video display device such that each individual signal from the plurality of video signals is viewable from a plurality of different angles with respect to the video display device.

### FIELD OF THE INVENTION

The present invention relates to the field of flat panel display systems. More particularly, embodiment of this present invention relates to displaying multiple images from a single display panel by redirecting light from individual pixels on the display to a plurality of predetermined viewing angles.

### BACKGROUND

For many years now, the resolution of displays, especially plasma or liquid crystal display (LCD) systems, have increased significantly. This has benefited the user in sharper high resolution images. However, there are many applications where it is desirable for individual users to be able to see different images from the same display. For example, the driver of an automobile might desire to view navigation or other driving aid information on an in-dash display while the passenger might desire to view movies or other entertainment related programs. In videoconferencing situations, individual participants might desire to view off-site participants from different angles to create a more seamless virtual environment. In video games, players may wish to view the game from their unique perspective. To accomplish the above examples using traditional displays would require one display for each image viewed. Besides being cost prohibitive, this method often is not feasible because of space constraints.

By showing multiple images on one display, considerable savings in cost and space can be achieved. Additionally, by limiting the viewability of each image to a single user, new desirable functionality is created. For example, by limiting entertainment programming viewability to the passenger, the driver of an automobile is less likely to be distracted from the task of driving. Airlines, instead of having one display for each passenger, can have one display in the center seat accessible by two or more passengers with differing programming demands, thus decreasing the cost of each plane as well as a reduction in weight. Another benefit to limiting viewability of each image is the ability to create three-dimensional (3-D) images. By producing a series of images that are separated by the average width between a user's eyes and restricting the viewability of that image to a specific eye, a 3-D image is created.

Current attempts to solve this problem have proven inadequate. For example, a parallax barrier (a screen with vertical transmissive slits separated by opaque regions, set in front of the display to restrict light transmitted through the pixels of certain output angles) can be used to create the desired effect. However, this method suffers light loss through the barrier and requires a symmetric set of viewing angles. It also suffers from resolution loss in the horizontal plane and is limited to only three views. Another method used in the past is the application of lenticular screens. These screens are comprised of an array of curved lenses used to direct interlaced images to multiple directions. This method, again results in resolution loss in the horizontal plane and the viewing angles have to be symmetric.

Therefore, what is desired is a system and method that overcomes challenges found in the art, including showing multiple images from a single display where each image can only be viewed from one angle from a plurality of possible angles and where the image does not suffer from resolution or light loss.

### SUMMARY OF THE INVENTION

In order to provide a 3-D image or multiple images on one display, it is desirable to have a system where each image can be viewed from a specific angle from a plurality of possible angles and where each image does not suffer from light or resolution loss. Embodiments according to the present invention can be regarded as a display system incorporating light pipes where a plurality of images are interlaced so that each vertical column or horizontal row of pixels on the display is associated with a specific image. Each column or row of pixels on the display relating to a specific image is associated with groupings of individual light pipes having the same refractive angle.

In one exemplary embodiment, the display system would be comprised of a quad-full high definition (Quad-HD) (3840×2160) LCD with an array of light pipes attached to the viewing surface of the display. Each light pipe in the array is associated with a particular pixel on the display. A video signal containing a plurality of interlaced images is displayed on the system. Individual pixels associated with a particular image within the plurality of images will have a light pipe with the same refractive angle allowing for viewing of one image and no others, at a predetermined angle relative to the viewing surface.

In one exemplary embodiment of a method for practicing an aspect of the invention, a method for generating multiple images on a video display device is described. The method comprises associating a panel of light pipes with a video display device. The video display device is configured to display an interlaced plurality of individual video signals. The plurality of video signals are displayed on the video display device such that each individual signal from the plurality of video signals is viewable from a plurality of different angles with respect to the video display device.

In one embodiment, the light pipes can be manufactured from acrylic. In other embodiments, the light pipes can be manufactured from silicon or polycarbinates.

Additional advantages will be set forth in part in the description which follows or may be learned by practice. The advantages will be realized and attained by means of the elements and combinations particularly pointed out in the appended claims. It is to be understood that both the foregoing general description and the following detailed description are examples and explanatory only and are not restrictive, as claimed.

### BRIEF DESCRIPTION OF THE DRAWINGS

The accompanying drawings, not drawn to scale, which are incorporated in and constitute a part of this specification, illustrate embodiments and together with the description, serve to explain the principles of the methods and systems:

FIG. 1 illustrates an embodiment of a multi-view display system where four images comprising of either still or motion pictures received by the display can be viewed simultaneously and without interference from the others depending on the relative angle position of the viewer;

FIG. 2 illustrates an embodiment of a multi-view display showing the layout of the light pipes in relationship to the display where the refraction of light from the display is achieved by using non-parallel surfaces at the ends of the light pipe;

FIG. 3 illustrates an expanded view of a display and the viewing angles for different viewers;

FIG. 4 illustrates an expanded view of a display setup for 3-D viewing;

FIGS. 5a and 5b illustrate embodiments of a light pipe where the pipe is straight and the viewing surface is angled; and

FIGS. 6a and 6b illustrate embodiments of a light pipes where the pipe is curved.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a”, “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

“Exemplary” means “an example of” and is not intended to convey a meaning of an ideal or preferred embodiment.

The present methods and systems may be understood more readily by reference to the following detailed description of preferred embodiments and the examples included therein and to the figures and their previous and following description.

Embodiments according to the invention can be understood in the context of a multi-view, multi-image display system where light pipes associated with a display direct interlaced images to multiple directions. This can be designed to give a 3-D image or provide multiple images in multiple directions.

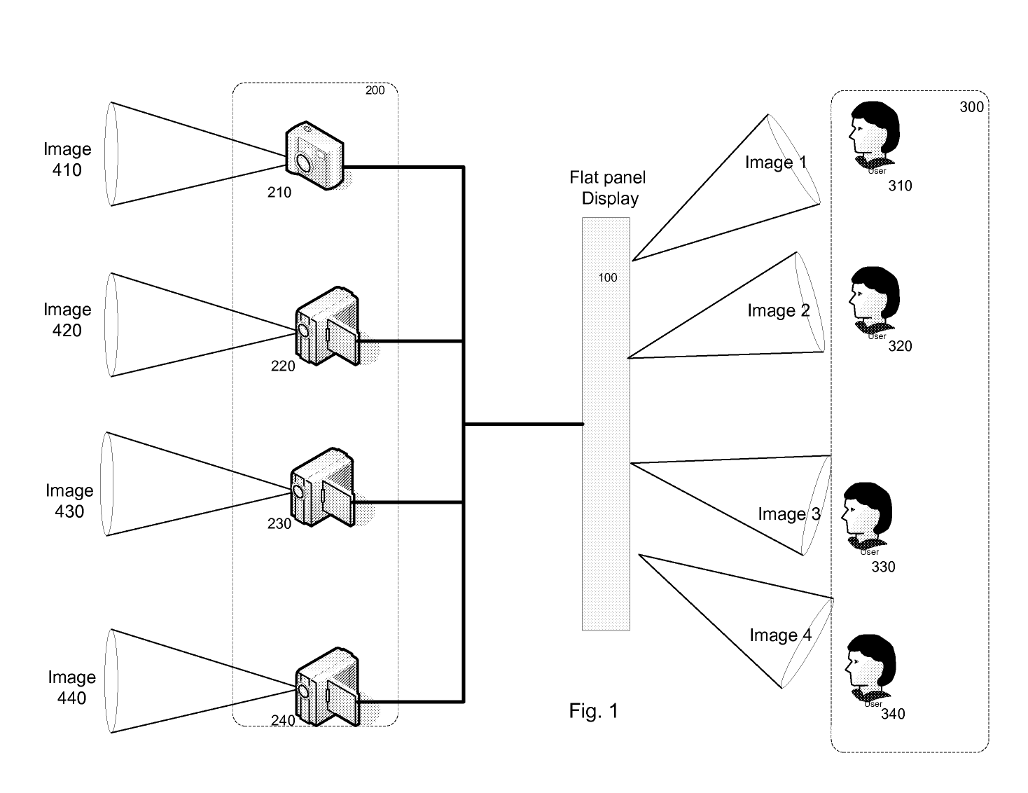

FIG. 1 illustrates a simplified non-limiting example of a display system. In this example, four images 410, 420, 430, 440 from four different sources 210, 220, 230, 240 are interlaced and sent to a flat panel display 100. Viewers 310, 320, 330, 340 can view one of the interlaced images 410, 420, 430, 440. The image 410, 420, 430, 440 each viewer 310, 320, 330, 340 sees, depends on the viewer's relative angle from the viewing surface of the display. Note in this embodiment, the four images are interlaced before being sent to the flat panel display 100. However, in other embodiments the images 410, 420, 430, 440 are interlaced internal to the flat panel display 100.

In accordance with the embodiments according to the present invention, the display can be comprised of a plasma or LCD flat panel display, among others, with a panel of light pipes attached to the viewing surface of the display. Other flat panel displays are also contemplated within the scope of this invention. Each light pipe is designed to maximize the transmission of light from the associated pixel and in one embodiment would match the size and surface shape of each pixel. Furthermore, each light pipe is designed to refract the light from each pixel to a predetermined plurality of angles.

In accordance with the embodiments according to the present invention, the image data from the plurality of images 410, 420, 430, 440 may be interlaced such that the data for each image appear on different vertical columns of pixels on the display 110. The interlaced images 410, 420, 430, 440 may be arranged such that vertical slices of each image translates to individual pixel columns on the display 100. The images may comprise of completely different images from different sources such as multiple video cameras 220, 230, 240 for video conferencing, or comprise of entertainment programming and navigational aid for vehicles or different viewpoint images of a game for multiple players or may form a stereoscopic image pair for autostereoscopic 3-D viewing.

In another embodiment, the image data from the plurality of images 410, 420, 430, 440 may be interlaced such that the data for each image appear on different horizontal rows of pixels on the display 110. The interlaced images 410, 420, 430, 440 may be arranged such that horizontal slices of each image translates to individual pixel rows on the display 100. The images may comprise of completely different images from different sources such as multiple video cameras 220, 230, 240 for video conferencing, or comprise of entertainment programming and navigational aid for vehicles or different viewpoint images of a game for multiple players or may form a stereoscopic pair for autostereoscopic 3D viewing.

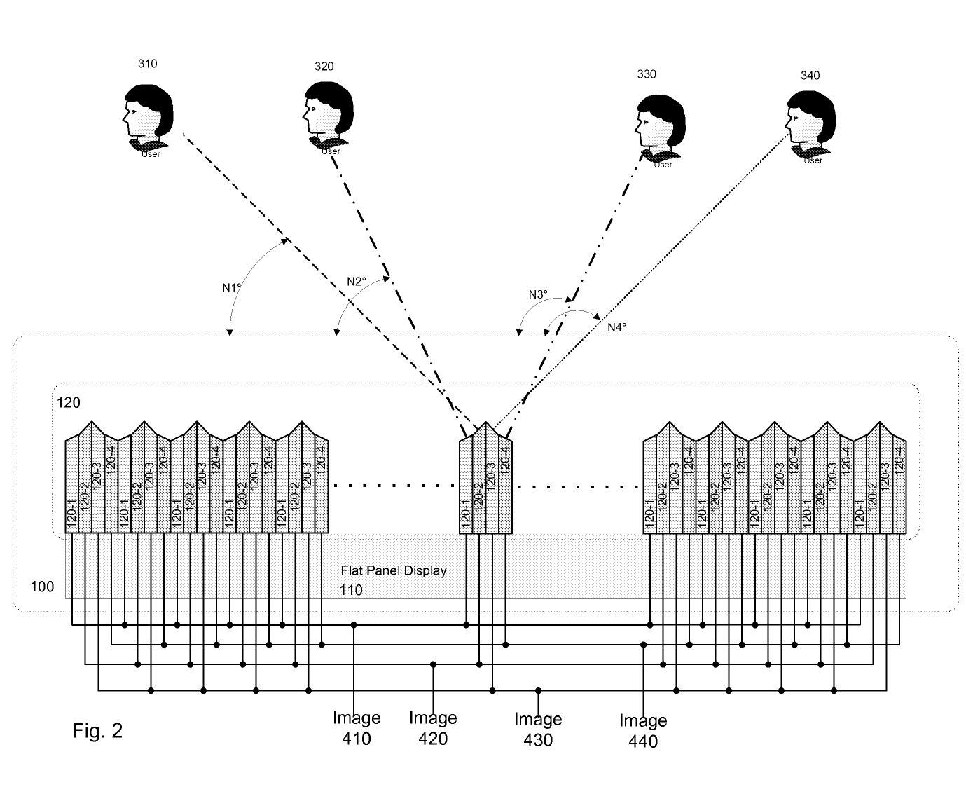

FIG. 2 illustrates a simplified non-limiting example of a light pipe panel 120. In this example, a light pipe panel 120 covers substantially all the pixels on a flat panel display 110 and is comprised of four distinct sets 120-1, 120-2, 120-3, 120-4. Each set of light pipes 120-1, 120-2, 120-3, 120-4 is designed to refract light from a flat panel display 110 at a different angle N1°, N2°, N3°, N4°. Data for the images 410, 420, 430, 440 may be interlaced such that slices of data for each individual image is displayed on rows or columns of pixels associated with one set of light pipes 120-1, 120-2, 120-3, 120-4. Note, while this embodiment has four viewing angles generated by four sets of light pipes, this number of angles is not required to practice the invention.

Additionally, the side of individual light pipes not necessary for transmission of light can be covered with a light blocking substance to maximize the contrast for light being emitted from the viewing surface, though this coating is not required to practice the invention.

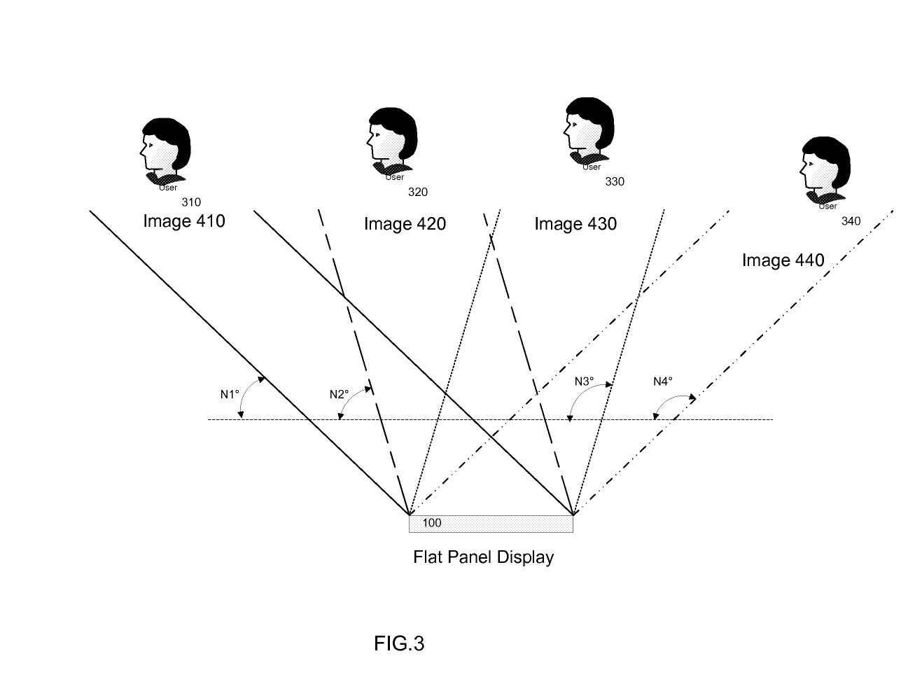

FIG. 3 illustrates how a viewing angle restricts viewing to an individual image within the plurality of interlaced images. Light from each light pipe on display 100 is refracted to a predetermined angle N1°, N2°, N3°, N4°. Viewers 310, 320, 330, 340 can view specific images that are refracted to specific angles by placing themselves within the viewing angle.

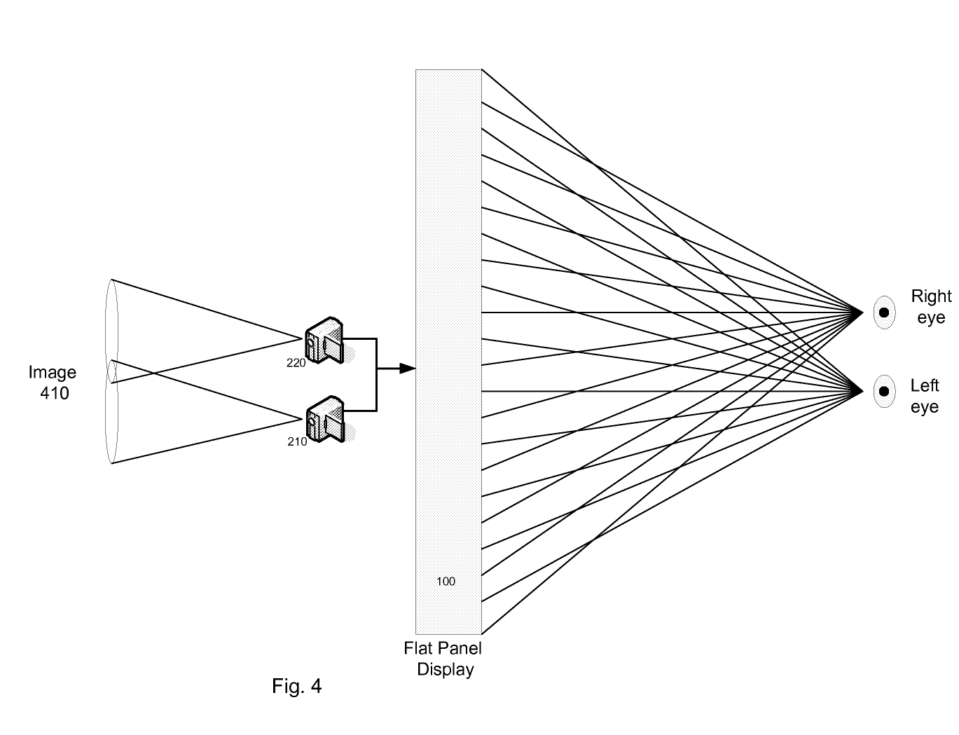

FIG. 4 illustrates an embodiment of the invention used for 3-D viewing. By adjusting the refraction angle of the light pipes, the left and right eye of individual viewers can view two different images. When interlaced properly, the images from the cameras 210, 220 will generate a 3-D view when the viewer is located at the correct angle and distance away from the display 100. In one embodiment, two cameras 210, 220 can be setup to record the same image but separated by the average distance between the left and right eye. The two signals are interlaced and displayed on the flat panel display 100. Through the light pipes, the image from camera 210 is refracted to the viewer's left eye, while the image from camera 220 is refracted to the viewer's right eye creating a stereoscopic image pair for autostereoscopic 3D viewing.

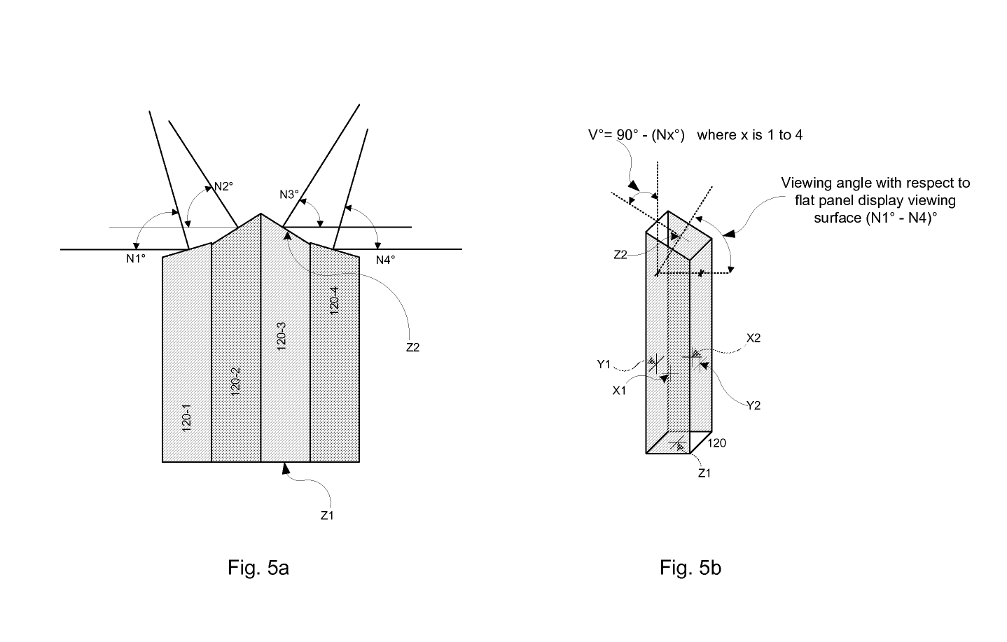

FIG. 5a illustrates a simplified non-limiting example of the possible light pipe 120. In this embodiment, light pipes 120-1, 120-2, 120-3, 120-4 are designed to refract light by angling the viewing surface Z2 relative to the surface where the light enters Z1.

FIG. 5b illustrates a simplified non-limiting example of the possible light pipe 120. In one embodiment of the invention, the vertical surface areas of a light pipe are covered with a light blocking substance. Sides X1, X2, Y1, Y2 of individual light pipes not necessary for transmission of light can be covered with a light blocking substance to maximize the contrast for light being emitted from the viewing surface Z2, though this coating is not required to practice the invention. The light pipe can be designed such that the angle of the viewing surface Z2 to side surfaces Y1, Y2 is a function of the viewing angle N1°, N2°, N3°, N4°. In this embodiment, sides X1, X2, Y1 and Y2 generally flat surfaces.

As shown in FIGS. 5a and 5b, one end of each light pipe is configured to be associated with a surface of a display device. The end facing away from the display device is angled relative to a surface of the video display device so as to refract light by angling the viewing surface Z2 relative to the surface where the light enters Z1. As shown in FIG. 5a, light pipes can be grouped to form a plurality of different angles with respect to the video display device such that a different viewing angle is provided for each group.

As shown with particular reference to FIG. 5b, one embodiment of a light pipe according to the present invention comprises angling the surface facing away from the video display device relative to the surface of the video display device while maintaining a relatively straight plane form on the other sides, such that the light pipe has a straight rectangular form factor and the viewing surface and the video display surface are angled from each other to provide the desired refraction angle while surfaces not used for viewing are straight.

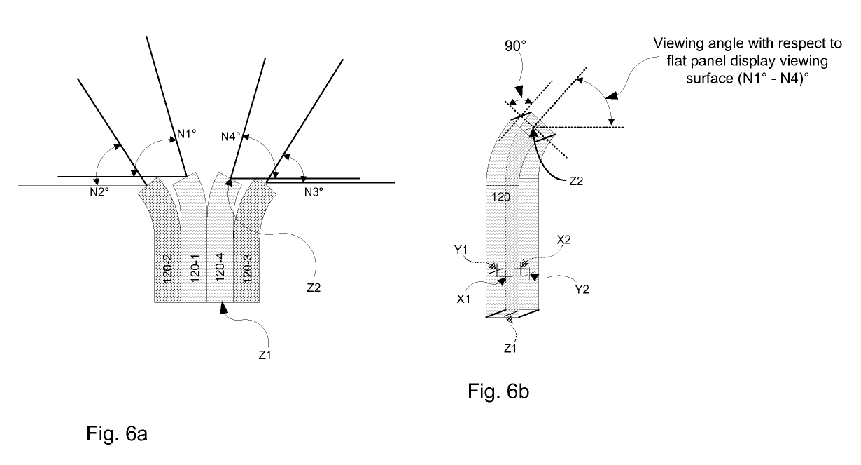

FIG. 6a depicts another non-limiting example of a possible light pipe 120. In this depiction, curved light pipes are used to refract light from a flat panel display. In this embodiment, curved light pipes 120-1, 120-2, 120-3, 120-4 are designed to refract light by angling the viewing surface Z2 relative to the surface where light enters Z1 by bending the light pipe.

FIG. 6b illustrates a simplified non-limiting example of the possible light pipe 120. In one embodiment of the invention, the vertical surface areas of a light pipe are covered with a light blocking substance. Sides X1, X2, Y1, Y2 of individual light pipes not necessary for transmission of light can be covered with a light blocking substance to maximize the contrast for light being emitted from the viewing surface Z2, though this coating is not required to practice the invention. The light pipe can be designed such that the angle of the viewing surface Z2 to side surfaces Y1, Y2 is generally 90° and the refraction is achieved by bending surfaces Y1 and Y2 of the light pipe to angle N1°, N2°, N3°, N4°.

As shown with particular reference to FIG. 6b, one embodiment of a light pipe according to the present invention comprises angling the surface facing away from the video display device relative to the video display device by bending or curving the light pipe, such that the refraction angle of the light pipe is reflected in the curved shape of the light pipe.

It is to be appreciated that contemplated within the scope of this invention are light pipes having various cross-sections or form factors such as square, rectangular, round, oval, etc.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as examples only, with a true scope and spirit being indicated by the following claims.

What is claimed is:

1. A method for generating multiple images on a video display device comprising:
attaching a panel of light pipes to the video display device;
interlacing a plurality of individual video signals for display on the video display device; and
displaying the plurality of video signals on the video display device such that each individual signal from the plurality of video signals is viewable from a plurality of different angles with respect to the video display device.

2. The method of claim 1, wherein generating multiple images on a video display device comprises generating multiple images on a plasma or a LCD flat panel display.

3. The method of claim 1, wherein attaching a panel of light pipes to the video display device comprises attaching a plurality of individual light pipes to the video display device.

4. The method of claim 3, wherein attaching a panel of light pipes to the video display device comprises sizing each of the plurality of individual light pipes such that each pixel that comprises the video display device is associated with one light pipe within the panel of light pipes.

5. The method of claim 3, wherein attaching a plurality of individual light pipes to the video display device comprises attaching a plurality of individual light pipes each having a surface facing away from the video display device that is angled relative to a surface of the video display device.

6. The method of claim 5, wherein the plurality of individual light pipes each having a surface facing away from the video display device that is angled relative to the surface of the video display device form the plurality of different angles with respect to the video display device.

7. The method of claim 5, wherein the plurality of individual light pipes each having a surface facing away from the video display device that is angled relative to the surface of the video display device form a plurality of groups of light pipes, wherein each group of light pipes is angled such that a different viewing angle is provided for each group.

8. The method of claim 5, wherein the individual light pipes each having a surface facing away from the video display device that is angled relative to the surface of the video display device comprises angling the surface facing away from the video display device relative to the surface of the video display device while maintaining a relatively straight plane form on the other sides, such that the light pipe has a straight rectangular form factor and the viewing surface and the video display surface are angled from each other to provide the desired refraction angle while surfaces not used for viewing are straight.

9. The method of claim 5, wherein the individual light pipes each having a surface facing away from the video display device that is angled relative to the surface of the video display device comprises angling the surface facing away from the video display device relative to the video display device by bending or curving the light pipe, such that the refraction angle of the light pipe is reflected in the curved shape of the light pipe.

10. A light pipe panel comprised of:
a plurality of individual light pipes, wherein each individual light pipe is configured to be associated with each individual pixel of a display panel,
wherein the plurality of individual light pipes are configured to provide separate images to a plurality of viewers viewing the display panel.

11. The light pipe panel of claim 10, wherein the individual light pipes are each comprised of a substantially straight rectangular light pipe with end surfaces that are angled from each other to provide the desired refraction angle.

12. The light pipe panel of claim 10, wherein the individual light pipes are comprised of light pipes with rectangular form factor where the light pipe is curved to create the desired refraction angle.

13. The light pipe panel of claim 10, wherein each individual light pipe has a rectangular cross-section.

14. The light pipe panel of claim 10, wherein each individual light pipe has a round or oval cross-section.

15. The light pipe panel of claim 10, wherein each individual light pipe is comprised of acrylic.

16. A method of displaying a plurality of video signals on a video display device from a plurality of different viewing angles comprising:
providing a video display device comprised of surface having a plurality of pixels;
associating each pixel on the video display device with one of the plurality of video signals;
associating each pixel on the video display device with a light pipe, wherein each light pipe has a surface away from the surface of the video display device at an angle relative to the surface of the video display device and the light pipes are formed into a plurality of groups such that the light pipes that comprise a group have substantially the same angle of the surface away from the surface of the video display device;
associating each video signal with one of the plurality of groups of light pipes;
simultaneously viewing each video signal that comprise the plurality of video signals from a different angle, wherein the different angle corresponds to the angle of the surface of the light pipes that comprise a group.

17. The method of claim 16, wherein the light pipe having a surface away from the surface of the video display at an angle relative to the surface of the video display device comprises a substantially straight light pipe that has an end cut or formed the angle relative to the surface of the video display device.

18. The method of claim 16, wherein the light pipe having a surface away from the surface of the video display at an angle relative to the surface of the video display device comprises a curved light pipe that forms the angle relative to the surface of the video display device.
